(19) United States
(12) Patent Application Publication
(10) Pub. No.: US 2019/0028626 A1
(43) Pub. Date: Jan. 24, 2019

(54) DISPLAY DEVICE, DISPLAY CONTROL METHOD, AND NON-TRANSITORY RECORDING MEDIUM

(71) Applicants: KABUSHIKI KAISHA TOSHIBA, Tokyo (JP); TOSHIBA TEC KABUSHIKI KAISHA, Tokyo (JP)

(72) Inventor: Minoru SUZUKI, Sagamihara Kanagawa (JP)

(21) Appl. No.: 15/653,529

(22) Filed: Jul. 19, 2017

(51) Int. Cl. H04N 5/225; G02F 1/1333; H04N 5/232

(52) U.S. Cl. CPC H04N 5/2258; H04N 2005/443; H04N 5/23293; G02F 1/13338

(57) ABSTRACT

A display device includes a touch panel and a control unit. The control unit is configured to: (i) detect a touch position on the touch panel on which a user selectable element is displayed, and determine a distance between the touch position and a display location of the user selectable element on the touch panel, (ii) update a touch accuracy metric when the distance is within a predetermined range, and (iii) select a display layout of the user selectable element based on the updated touch accuracy metric.

### FIELD

Embodiments described herein relate generally to a display device, a display control method, and a non-transitory recording medium.

### BACKGROUND

An image forming device which includes a touch panel on which an image for operation (also referred to herein as a user-selectable element), such as a button or an icon, is displayed, is known. The image forming device detects a touch position on the touch panel. Accuracy of the touch position varies for each user. Therefore, there is provided a technology that enlarges or shifts an area displayed on the touch panel on which it is determined that the image for operation is touched.

In the technology, the area is enlarged or shifted for a user where the accuracy of the touch position is low.

### DESCRIPTION OF THE DRAWINGS

FIG. 1 illustrates a schematic configuration of an image forming device according to an exemplary embodiment.

FIG. 2A illustrates a screen of a standard layout.

FIG. 2B illustrates a screen of a high-accuracy layout.

FIG. 2C illustrates a screen of a high-accuracy layout.

FIG. 2D illustrates a screen of a low-accuracy layout.

FIG. 3 is a flowchart illustrating an operation of the image forming device.

FIG. 4 illustrates layouts, in which an area to be displayed is changed, from a reference layout.

FIG. 5 illustrates examples of layouts in which shapes of operation buttons are changed.

### DETAILED DESCRIPTION

A display device includes a touch panel and a control unit. The control unit is configured to: (i) detect a touch position on the touch panel on which a user selectable element is displayed, and determine a distance between the touch position and a display location of the user selectable element on the touch panel, (ii) update a touch accuracy metric when the distance is within a predetermined range, and (iii) select a display layout of the user selectable element based on the updated touch accuracy metric.

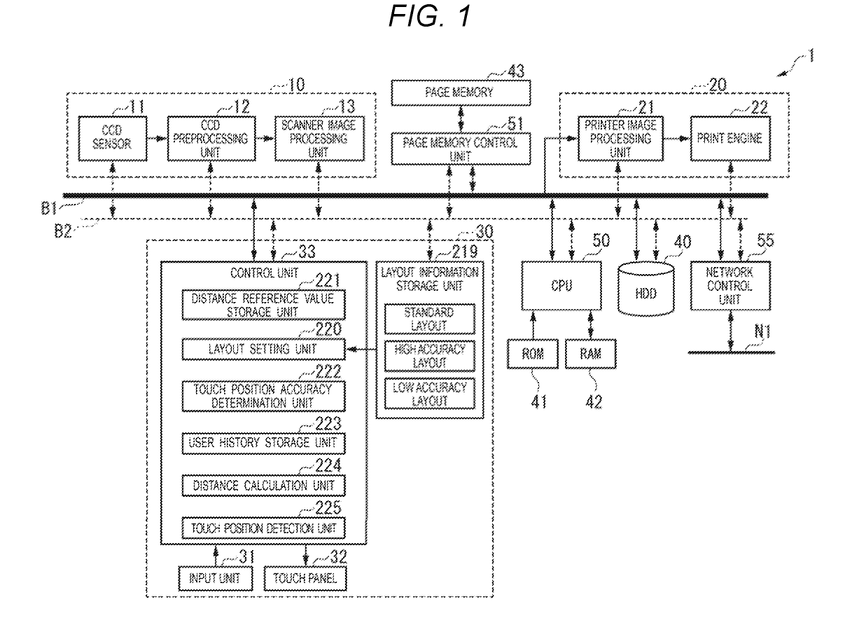

FIG. 1 is a view illustrating a schematic configuration of an image forming device 1 according to an exemplary embodiment.

The image forming device 1 includes a scanner 10, a printer 20, a control panel 30, a Hard Disk Drive (HDD) 40, a Read Only Memory (ROM) 41, and a Random. Access Memory (RAM) 42. In addition, the image forming device 1 includes a Central Processing Unit (CPU) 50, a page memory 43, a page memory control unit 51, and a network control unit 55.

Meanwhile, the scanner 10, the printer 20, the control panel 30, the HDD 40, and the CPU 50 are connected through a common bus B1. In addition, these elements are connected to the page memory control unit 51 and the network control unit 55 through the common bus B1. In addition, the image forming device 1 is connected to a network N1.

In addition, each of the control units and each of the processing units included in the image forming device 1 may be implemented by, for example, hardware, such as an Application Specific Integrated Circuit (ASIC). Here, for example, the page memory control unit 51, or the like may also be included in a group of the control units and the processing units, which is implemented by the hardware.

The scanner 10 includes a Charge Coupled Device (CCD) sensor 11, a CCD preprocessing unit 12, and a scanner image processing unit 13.

The CCD sensor 11 is an image sensor that reads an image on a document by the CCD and converts the image, which is read, into image data. The CCD sensor 11 reads image information of the document which is positioned at a reading position of the scanner 10. Furthermore, the CCD sensor 11 outputs the image data, which is acquired by converting the read image information, as an analog signal.

The CCD preprocessing unit 12 generates a control signal which drives the CCD sensor 11. The CCD preprocessing unit 12 converts the analog signal, which is acquired when the CCD sensor 11 reads the document, into a digital signal. The CCD preprocessing unit 12 outputs the image information, which is read by the CCD sensor 11, as the image data based on the digital signal acquired through the conversion.

The scanner image processing unit 13 performs various image processes on the image data which is output by the CCD preprocessing unit 12. The scanner image processing unit 13 performs an image process which is necessary for a process at a latter part. Here, the image process which is necessary for the process at the latter part includes, for example, correction related to properties of the CCD, correction related to an optical system of the scanner 10, correction of a dynamic range, correction of a filtering function, and the like. The scanner image processing unit 13 outputs the image data, on which the image process is performed, to each of the units through the common bus B1. The printer unit 20 includes a printer image processing unit 21 and a print engine 22. The print engine 22 forms an image, based on the image data processed by the printer image processing unit 21, on a sheet using a developer. The sheet may be, for example, paper or label paper. Any type of sheet having a surface, on which it is possible to form an image by the print engine 22, may be used.

The HDD 40 stores various files, such as image data files read by the scanner 10, which are used for various processes in the image forming device 1.

The ROM 41 stores a control program. The RAM 42 temporally stores various data which are used for processes performed by the CPU 50.

The CPU 50 integrally controls the whole image forming device 1. The CPU 50 performs a process using the RAM 42 according to the control program stored in the ROM 41. The CPU 50 performs processes of outputting setting and an instruction to each of the units through the common bus B1 for the CPU 50, reading a result of the process of each of the units, and the like.

The page memory 43 may be, for example, a volatile memory, and temporally stores image data corresponding to one or more pages of the document.

The page memory control unit 51 performs write control and read control of the image data stored in the page memory 43.

The control panel 30 includes an input unit 31, a touch panel 32, a layout information storage unit 219, and a control unit 33. The control unit 33 includes a layout setting unit 220, a touch position detection unit 225, and a distance calculation unit 224. Furthermore, the control unit 33 includes a user history storage unit 223, a touch position accuracy determination unit 222, and a distance reference value storage unit 221. The control panel 30 is an example of the display device. In addition, the control panel 30 includes an arithmetic unit, such as a CPU, and a storage unit such as a ROM or a RAM. Meanwhile, the ROM of the control panel 30 is a rewritable flash memory.

The input unit 31 may include, for example, a hard key, and acquires various operation inputs performed by an operator, or setting information, instruction information, and the like.

The touch panel 32 is superimposed on, for example, the display device such as a liquid crystal display. Therefore, the touch panel 32 is capable of displaying various images such as images for operation. The images for operation, also referred to herein as user selectable elements, are operation buttons and icons which are selected by the user to perform desired operations. In addition, the touch panel 32 is capable of displaying a preview image or the like.

The control unit 33 controls the input unit 31 and the touch panel 32 of the control panel 30. That is, the control unit 33 causes the touch panel 32 to display a predetermined screen, such as an operating screen and a setting screen. Furthermore, the control unit 33 controls input of an operation or setting performed by the operator through the input unit 31 and the touch panel 32.

The touch position detection unit 225 of the control unit 33 detects a touch position, which is touched by the user, on the touch panel 32. The touch position is expressed with coordinates (x,y) in an XY plane in which, for example, a lower left vertex of the touch panel 32 is used as an original point. Meanwhile, although touch by the user becomes an area instead of a point because a finger is touched, a point (for example, a center or the like) in the area is detected as the touch position. The touch position detection unit 225 outputs the detected touch position to the distance calculation unit 224.

The distance calculation unit 224 of the control unit 33 calculates a distance from the touch position, which is output by the touch position detection unit 225, to an area where the image for operation is displayed. The distance calculation unit 224 specifies the image for operation which includes the touch position in the area thereof. The distance calculation unit 224 acquires coordinates of the specified image for operation.

The distance calculation unit 224 of the control unit 33 calculates a Euclidean distance from the coordinates of the touch position output by the touch position detection unit 225 and the coordinates of the specified image for operation. The distance calculation unit 224 outputs the calculated distance to the user history storage unit 223.

Meanwhile, the coordinates of the image for operation are coordinates of the center of the area in which the image for operation is displayed. The distance calculation unit 224 updates the coordinates of the image for operation in advance. In addition, when the image for operation, which includes the touch position in the area thereof, does not exist, the distance calculation unit 224 does not calculate the distance. In the description below, there is a case where “touch position is available” is expressed when the image for operation, which includes the touch position in the area thereof, exists.

The user history storage unit 223 of the control unit 33 associates a user ID with a distance which is output from the distance calculation unit 224, and stores the user ID and the distance in the RAM of the control panel 30. The user ID is an identifier which uniquely identifies the user.

The user history storage unit 223 of the control unit 33 associates the input user ID with the distance which is output from the distance calculation unit 224, and stores the user ID and the distance from when the user ID is input to when the user logs out. For example, distances (d1 to d5) corresponding to five times are output from the distance calculation unit 224 from when a user who has a user ID “123” logs in and to when the user logs out. Here, the user history storage unit 223 stores data (123, d1, d2, . . . , d5), which is acquired by associating the ID with the distances, as the history. When the user logs out, the user history storage unit 223 outputs the stored history to the touch position accuracy determination unit 222.

The distance reference value storage unit 221 of the control unit 33 stores reference, which is used to determine the accuracy of the touch position by the touch position accuracy determination unit 222, in the ROM of the control panel 30. The reference includes two numerical values S1 and S2 (S1<S2). The distance reference value storage unit 221 outputs the two numerical values S1 and S2 to the touch position accuracy determination unit 222. The two numerical values S1 and S2 are examples of a predetermined reference.

The touch position accuracy determination unit 222 of the control unit 33 determines the accuracy of the touch position based on the history which is output from the user history storage unit 223. The touch position accuracy determination unit 222 calculates an average A of the distances based on the history. For example, when the history is (123, d1, d2, . . . , d5), the touch position accuracy determination unit 222 calculates the average A=(d1+d2+ . . . +d5)/5. Subsequently, magnitude relations between the average A and the determination reference values S1 and S2 are compared. The touch position accuracy determination unit 222 updates a result of determination, which is acquired through the comparisons between the average and the determination reference values S1 and S2, in the RAM of the control panel 30. The result of determination may include “high accuracy”, “standard”, and “low accuracy”.

The touch position accuracy determination unit 222 stores the result of determination for each user. When A<S1, the touch position accuracy determination unit 222 determines that the accuracy of the touch position is high compared to the predetermined reference. In this case, the touch position accuracy determination unit 222 sets the result of determination to “high accuracy”.

When S1≤A≤S2, the touch position accuracy determination unit 222 determines that the accuracy of the touch position is standard accuracy, compared to the predetermined reference. In this case, the touch position accuracy determination unit 222 sets the result of determination to “standard”.

When S2<A, the touch position accuracy determination unit 222 determines that the accuracy of the touch position is low accuracy, compared to the predetermined reference. In this case, the touch position accuracy determination unit 222 sets the result of determination to “low accuracy”.

Meanwhile, there is a case where the result of determination corresponding to the user ID does not exist. For example, there is a case where it is the first time for the user corresponding to the user ID to use the image forming device 1. In this case, the touch position accuracy determination unit 222 sets the result of determination to “non-applicable”.

The touch position accuracy determination unit 222 outputs the result of determination, which is output by the touch position accuracy determination unit 222, to the layout setting unit 220. The layout setting unit 220 sets the layout of the images for operation, which are displayed on the touch panel 32, according to the accuracy of the touch position. That is, the layout setting unit 220 sets the layout according to the result of determination by the touch position accuracy determination unit 222.

The layout setting unit 220 sets the layout of the images for operation from three types of layouts which are stored in the layout information storage unit 219. The layout information storage unit 219 stores a standard layout, a high-accuracy layout, and a low-accuracy layout in the ROM of the control panel 30. In the standard layout, the high-accuracy layout, and the low-accuracy layout, operation button sizes are different. The standard layout, the high-accuracy layout, and the low-accuracy layout are determined in advance. Meanwhile, the “operation button size” indicates a dimension of an operation button to be displayed. Accordingly, shapes of operation buttons in different layouts may not be similar.

The standard layout is a layout corresponding to the result of determination “standard”. The high-accuracy layout is a layout corresponding to the result of determination “high accuracy”. The low-accuracy layout is a layout corresponding to the result of determination “low accuracy”.

The layout setting unit 220 sets the layout corresponding to the result of determination which is output from the touch position accuracy determination unit 222. Meanwhile, in a case where the result of determination is “non-applicable”, the layout setting unit 220 sets the standard layout.

A screen of the layout, which is output from the layout setting unit 220, is displayed on the touch panel 32.

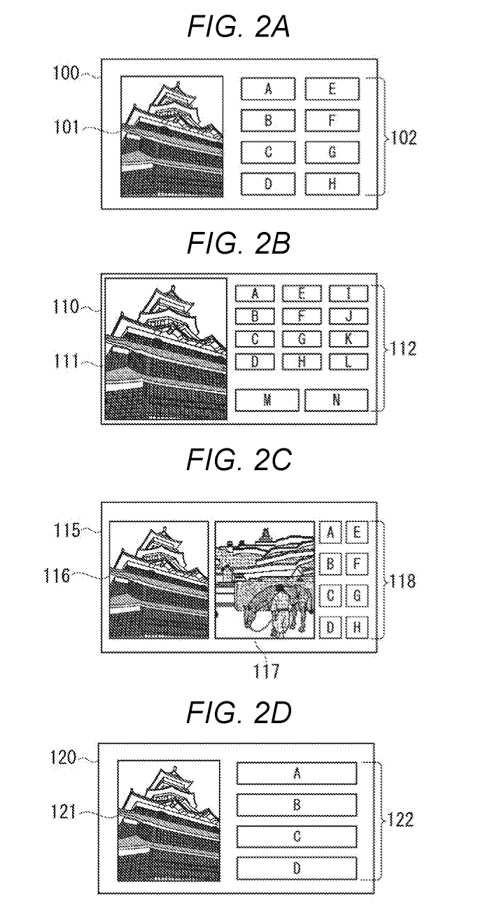

FIG. 2A is a view illustrating a screen 100 of the standard layout. As described above, the standard layout is a layout corresponding to the result of determination “standard”. The screen 100 includes a preview display area 101 and an operation button group 102. The operation button group 102 includes 8 operation buttons A to H. The operation buttons A to H are examples of a standard image for operation. In addition, the operation buttons A to D are buttons to perform basic functions. For example, the operation button A is a button to perform copying, the operation button B is a button to perform scanning, the operation button C is a button to perform printing, and the operation button D is a button to perform sending a facsimile.

FIG. 2B is a view illustrating a screen 110 of the high-accuracy layout. As described above, the high-accuracy layout is a layout corresponding to the result of determination “high accuracy”. The screen 110 includes a preview display area 111 and an operation button group 112. The operation button group 112 includes 14 operation buttons A to N. The operation buttons A to N are examples of the image for operation. In the screen of the high-accuracy layout, the preview display area 111 becomes large and the number of operation buttons is increased by 6, compared to the screen of the standard layout.

In the high-accuracy layout, operation buttons A to H are smaller than the operation buttons A to H in the standard layout. In addition, the high-accuracy layout includes operation buttons A to H which are acquired by reducing the sizes of the operation buttons displayed in the standard layout. Furthermore, as illustrated in FIG. 2B, the high-accuracy layout is a layout in which the number of operation buttons (14) is acquired by being increased from the number of operation buttons (8) displayed in the standard layout.

FIG. 2C is a view illustrating a screen 115 which is an example of another screen of the high-accuracy layout. The screen 115 includes preview display areas 116 and 117 and an operation button group 118. The operation button group 118 includes 8 operation buttons A to H, similarly to the operation buttons A to H in the standard layout. The operation buttons A to H are examples of the image for operation.

Since two preview display areas are provided in the screen 115, the user is capable of comparing images easily on the screen 115. Meanwhile, although the screen 115 is provided with two preview display areas, three or more preview display areas may be provided in the screen 115.

FIG. 2D is a view illustrating a screen 120 of the low-accuracy layout. As described above, the low-accuracy layout is a layout corresponding to the result of determination “low accuracy”. The screen 120 includes a preview display area 121 and an operation button group 122. The operation button group 122 includes 4 operation buttons A to D. The operation buttons A to D are examples of the image for operation. The screen in the low-accuracy layout, the number of operation buttons is decreased by 4, compared to the screen of the standard layout.

In the low-accuracy layout, the operation buttons A to D are larger than the operation buttons A to D in the standard layout. Furthermore, the low-accuracy layout is a layout in which a part of the operation buttons E to H in the standard layout is not included. As described above, the operation buttons A to D are buttons to perform basic functions, and thus it is possible to maintain convenience even in the low-accuracy layout.

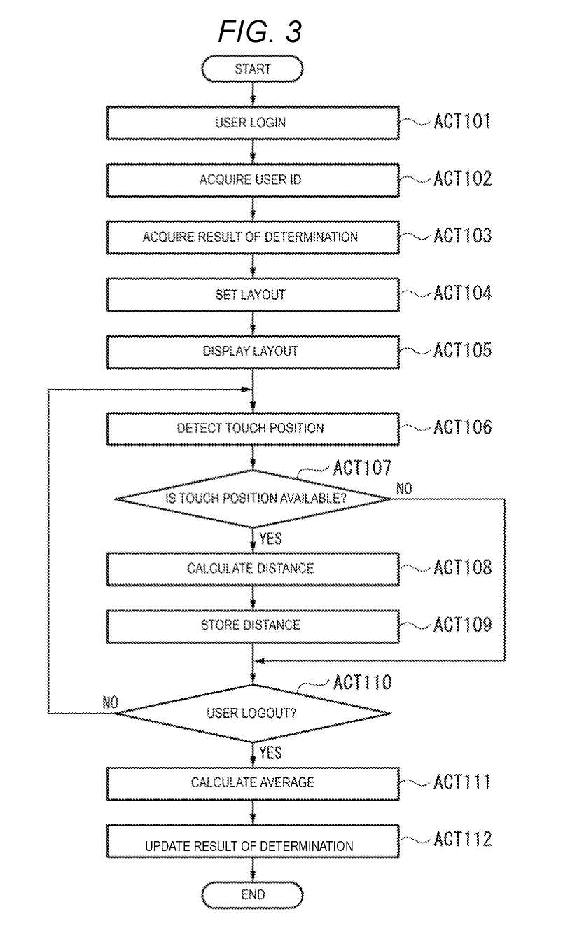

FIG. 3 is a flowchart illustrating an operation of the image forming device 1 according to the exemplary embodiment. If it is determined that the user logs in (ACT101), the control unit 33 acquires the user ID which is input when the user logs in (ACT102).

The control unit 33 acquires the result of determination from the touch position accuracy determination unit 222 (ACT103). The layout setting unit 220 sets the layout according to the result of determination (ACT104). The control unit 33 displays the screen of the layout, which is set by the layout setting unit 220, on the touch panel 32.

The control unit 33 detects the touch position (ACT106). The control unit 33 determines whether or not the touch position is available (ACT107). When the touch position is not available (ACT107: NO), the control unit 33 proceeds to ACT110 without calculating the distances. When the touch position is available (ACT107: YES), the control unit 33 calculates the distances (ACT108).

The control unit 33 associates the user ID with the calculated distance, and stores the user ID and the calculated distance (ACT109). The control unit 33 determines whether or not the user logs out (ACT110).

If the user does not log out (ACT110: NO), the process returns to ACT106, and the touch position is detected. When the user logs out (ACT110: YES), the control unit 33 calculates an average of the distances based on the history (ACT111). The control unit 33 updates the result of determination, which is acquired by comparing the average with the determination reference values S1 and S2, together with the user ID (ACT112).

The result of determination acquired as described above is reflected on selection of a layout of the images for operation which is displayed when the user logs in next time.

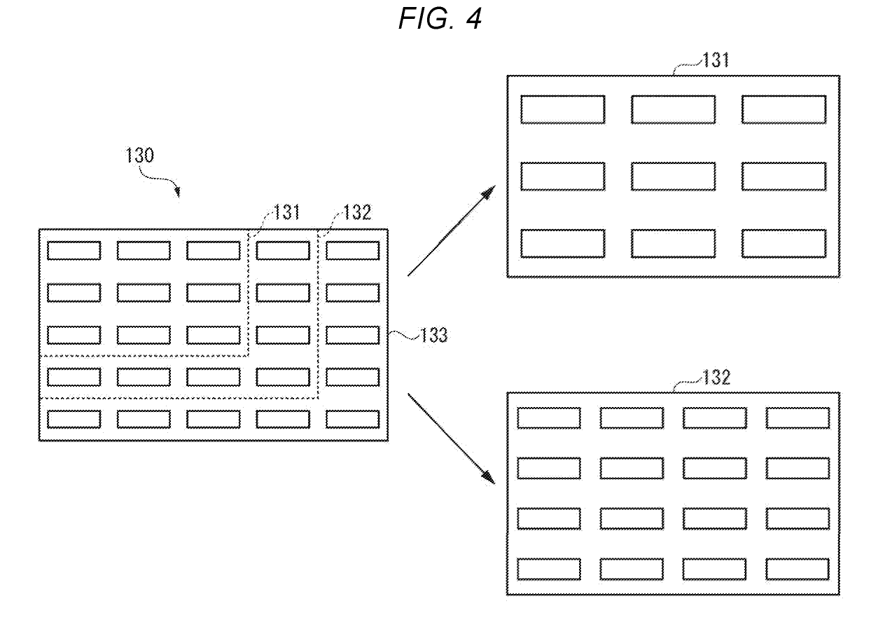

Subsequently, an example of another layout will be described. FIG. 4 is a view illustrating layouts in which an area to be displayed is changed from a reference layout. FIG. 4 illustrates a reference layout 130, a low-accuracy layout 131, a standard layout 132, and a high-accuracy layout 133.

In the reference layout 130, 25 operation buttons are provided in a screen. The low-accuracy layout 131 is a layout which includes 9 operation buttons located on the upper left of the reference layout 130. The low-accuracy layout 131 is enlarged and displayed. With the enlargement, the operation buttons are also enlarged.

The standard layout 132 is a layout which includes 16 operation buttons located on the upper left of the reference layout 130. Although the low-accuracy layout 132 does not have an enlargement ratio as large as the low-accuracy layout, the low-accuracy layout 132 is enlarged and displayed. With the enlargement, the operation buttons are also enlarged.

The high-accuracy layout 133 is, for example, the reference layout 130. The reference layout may be provided in advance and another layout may be displayed by enlarging a part of the reference layout as illustrated in FIG. 4. Meanwhile, although an upper left area is set to another layout in FIG. 4, for example, a central area or the like may be another layout.

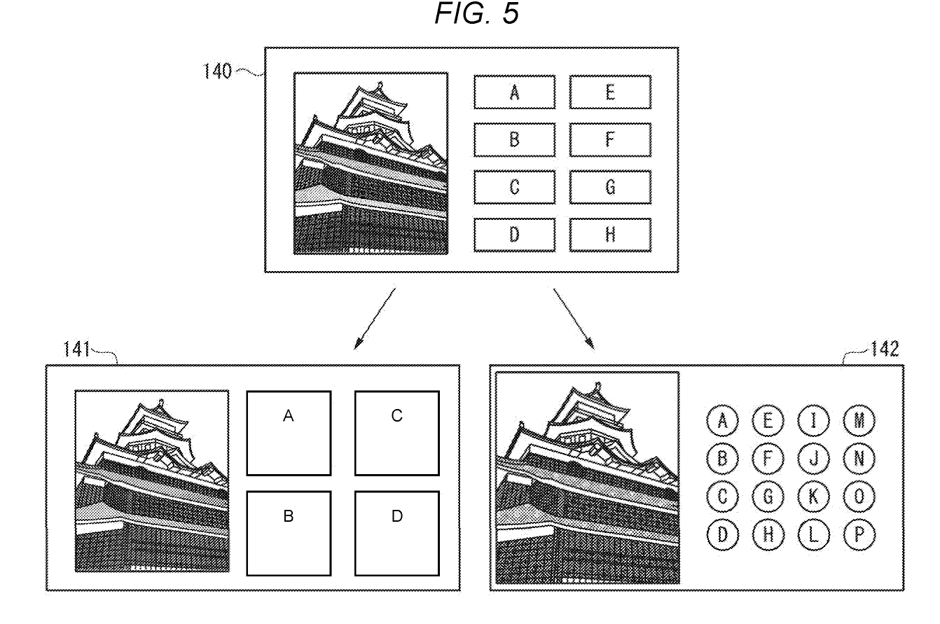

FIG. 5 is a view illustrating an example of a layout in which shapes of the operation buttons are changed. FIG. 5 illustrates a standard layout 140, a low-accuracy layout 141, and a high-accuracy layout 142.

In the standard layout 140, the operation buttons are displayed in rectangular shapes. In low-accuracy layout 141, the operation buttons are displayed in square shapes. In the high-accuracy layout 142, the operation buttons are displayed in circular shapes. As described above, the control unit 33 may set a layout, in which the shapes of the operation buttons are changed, as a layout of the operation buttons displayed on the touch panel.

In a case of the low-accuracy layout 141, the control unit 33 displays the operation buttons in large square shapes. Accordingly, operability is significantly improved. In contrast, in a case of the high-accuracy layout 142, the control unit 33 displays the operation buttons by circles. Accordingly, it is possible to effectively use an area, and the number of operation buttons, which can be displayed for the user, is significantly increased.

In the above-described exemplary embodiment, the control unit 33 determines the accuracy by calculating the average. However, the exemplary embodiment is not limited thereto. For example, the control unit 33 may determine the accuracy by acquiring a maximum value based on the history. In this case, the control unit 33 may store only the maximum value, and thus it is possible to simplify the process. Specifically, the control unit 33 compares the distances, which are output from the distance calculation unit 224, with a distance, which is currently updated, and updates only larger one. Therefore, it is possible to reduce the consumption of the memory. Furthermore, the control unit 33 determines the accuracy of the touch position by comparing a reference maximum value and the maximum value.

Furthermore, the control unit 33 may determine the accuracy using variance or standard deviation. For example, when the variance or the standard deviation is relatively small, the control unit 33 may determine the accuracy using the maximum value. In addition, comparatively large variance or standard deviation means a wide variation, and thus the control unit 33 may determine the low accuracy with only the variance or the standard deviation.

In the exemplary embodiment, the result of determination is reflected in a layout which is displayed when the user logs in next time. However, the exemplary embodiment is not limited thereto. For example, the layout may be dynamically changed while the user is performing an operation. In this case, the control unit 33 determines the accuracy, for example, whenever tenth touch position is detected. The control unit 33 changes the layout according to the result of determination of accuracy of the touch position. Meanwhile, when the control unit 33 dynamically changes the layout, the layout may be changed after change permission is acquired from the user.

In addition, the layout may not be changed whenever different results of the determination are acquired. For example, in a case of a user whose result of the current determination is “standard”, the layout may be changed to the low-accuracy layout when subsequent results of the determination are continuously “low accuracy” in plurality of times. In this manner, the layout is not frequently changed, and thus it is possible for the user to perform an operation without feeling uncomfortable.

In the above-described exemplary embodiment, the control unit 33 calculates the Euclidean distance based on the coordinates of the touch position and the coordinates of the specified image for operation. However, the exemplary embodiment is not limited thereto. For example, the control unit 33 may calculate the shortest distance between the coordinates of the touch position and an outline of the image for operation.

Meanwhile, in the above-described exemplary embodiment, the operation buttons are used as an example of the image for operation. The exemplary embodiment is not limited thereto. An image, such as an icon, a slide button, or a pull-down menu, which is related to an operation, may be the image for operation. In addition, as illustrated in FIG. 2, a screen other than a screen, such as a preview screen, which is relevant to an operation, may be enlarged or reduced according to accuracy.

According to the above-described exemplary embodiment, it is possible to improve convenience by setting the layout of the image for operation displayed on the touch panel according to the accuracy of the touch position. Specifically, it is possible to improve convenience by displaying a low-accuracy layout screen to a low-accuracy user. Stress extremely builds up in the low-accuracy user when it is determined that another operation button is erroneously pressed. Accordingly, the exemplary embodiment is extremely effective for the low-accuracy user. In contrast, it is possible to improve convenience by displaying a high-accuracy layout screen to a high-accuracy user. Since a plurality of operation buttons are displayed on the high-accuracy layout screen as described above, convenience is improved, compared to the standard layout or the low-accuracy layout. Accordingly, the exemplary embodiment is also extremely effective for the high-accuracy user. In addition, for a standard-accuracy user, it is possible to improve convenience by displaying a standard layout screen.

As described above, according to the exemplary embodiment, it is possible to improve convenience for all the high-accuracy, the low-accuracy, or the standard-accuracy users. That is, according to the exemplary embodiment, it is possible to improve convenience of all the users.

Meanwhile, the control unit 33 as a main subject, which performs the flowchart of FIG. 3, is described as an example. However, for example, the CPU 50 may be the main subject which performs the flowchart of FIG. 3. In this case, the ROM 41 stores a program which is executed by each unit included in the control unit 33. Furthermore, the ROM 41 stores three types of layouts which are stored in the layout information storage unit 219. The CPU 50 executes the program stored in the ROM 41. Therefore, it is possible to cause the CPU 50 to be the main subject which performs the flowchart of FIG. 3.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

What is claimed is:

1. A display device comprising:
a touch panel; and
a control unit configured to detect a touch position on the touch panel on which a user selectable element is displayed, and determine a distance between the touch position and a display location of the user selectable element on the touch panel, update a touch accuracy metric when the distance is within a predetermined range, and select a display layout of the user selectable element based on the updated touch accuracy metric.

2. The device according to claim 1,
wherein the control unit is configured to maintain a touch accuracy metric separately for each different user.

3. The device according to claim 1,
wherein the control unit selects the display layout of the user selectable element from a plurality of display layouts of different densities.

4. The device according to claim 3, wherein the touch accuracy metric is an average of the distances that are within the predetermined range.

5. The device according to claim 4, wherein the control units selects a standard display layout for the user selectable element if the touch accuracy metric is between a first threshold distance and a second threshold distance which is greater than the first threshold distance.

6. The device according to claim 5, wherein the control units selects a higher density display layout for the user selectable element than the standard display layout if the touch accuracy metric is less than the first threshold distance.

7. The device according to claim 5, wherein the control units selects a lower density display layout for the user selectable element than the standard display layout if the touch accuracy metric is greater than the second threshold distance.

8. The device according to claim 1, wherein
the display layout is changed from an old display layout to a new display out as a result of the control unit selecting the display layout, and
the user selectable element in the new display layout has a shape that is different from that of the user selectable element in the old display layout.

9. A display control method for a display device, comprising:
detecting a touch position on a touch panel on which a user selectable element is displayed;
determining a distance between the touch position and a display location of the user selectable element on the touch panel;
when the distance is within a predetermined range, updating a touch accuracy metric, and
selecting a display layout of the user selectable element based on the touch accuracy metric.

10. The display control method according to claim 9, further comprising:
maintaining a touch accuracy metric separately for each different user.

11. The display control method according to claim 9,
wherein the display layout of the user selectable element is selected from a plurality of display layouts of different densities.

12. The display control method according to claim 11, wherein the touch accuracy metric is an average of the distances that are within the predetermined range.

13. The display control method according to claim 12, wherein a standard display layout for the user selectable element is selected if the touch accuracy metric is between a first threshold distance and a second threshold distance which is greater than the first threshold distance.

14. The display control method according to claim 13, wherein a higher density display layout for the user selectable element than the standard display layout is selected if the touch accuracy metric is less than the first threshold distance.

15. The display control method according to claim 13, wherein a lower density display layout for the user selectable element than the standard display layout is selected if the touch accuracy metric is greater than the second threshold distance.

16. The display control method according to claim 9, wherein
the display layout is changed from an old display layout to a new display out as a result of the control unit selecting the display layout, and
the user selectable element in the new display layout has a shape that is different from that of the user selectable element in the old display layout.

17. A non-transitory recording medium that stores a computer program which causes a computer to perform a display control method comprising the steps of:
determining a distance between the touch position and a display location of the user selectable element on the touch panel;
when the distance is within a predetermined range, updating a touch accuracy metric, and
selecting a display layout of the user selectable element based on the touch accuracy metric.

18. The non-transitory recording medium according to claim 9, wherein
the display layout of the user selectable element is selected from a plurality of display layouts of different densities, and
the touch accuracy metric is an average of the distances that are within the predetermined range.

19. The non-transitory recording medium according to claim 12, wherein a standard display layout for the user selectable element is selected if the touch accuracy metric is between a first threshold distance and a second threshold distance which is greater than the first threshold distance.

20. The display control method according to claim 13, wherein
a higher density display layout for the user selectable element than the standard display layout is selected if the touch accuracy metric is less than the first threshold distance, and
a lower density display layout for the user selectable element than the standard display layout is selected if the touch accuracy metric is greater than the second threshold distance.
